(19) United States
(12) Patent Application Publication
(10) Pub. No.: US 2023/0146022 A1
(43) Pub. Date: May 11, 2023

(54) DEVICE AND METHOD FOR FIRMLY GRIPPING AN OBJECT, SUCH AS A CONTAINER OR JAR

(71) Applicant: John S. Gilbert, Somers, NY (US)

(72) Inventor: John S. Gilbert, Somers, NY (US)

(21) Appl. No.: 18/151,179

(22) Filed: Jan. 6, 2023

Related U.S. Application Data
(63) Continuation of application No. 15/906,356, filed on Feb. 27, 2018, now Pat. No. 11,603,303.
(60) Provisional application No. 62/614,622, filed on Jan. 8, 2018.

(51) Int. Cl. B67B 7/18

(52) U.S. Cl. CPC B67B 7/186

(57) ABSTRACT

A strap wrench device includes (a) an elongate, flexible member having a first end and a second end; and (b) an elongate handle having a proximal end, a distal end, a face side and a back side. The handle is configured to be conveniently held in a user's right hand with its proximal end extending toward the object to be gripped. The proximal end of the handle has a means on its right side (when held by a user with its the face side upward) for attaching the first end of the flexible member. It also has an opening adjacent the handle's left side through which the second end of the flexible member can pass. The flexible member extends through the opening in the handle, thereby forming a loop that can surround and grip an object. The flexible member then extends further along the left side of the handle toward the handle's distal end. The handle includes a rounded protrusion at its proximal end, adjacent to the opening and on a side of the opening that is opposite to the flexible member attachment means, for pressing the flexible member against the gripped object when the device is in use.

### CROSS-REFERENCE TO RELATED APPLICATION

This application is a Continuation application of U.S. application Ser. No. 15/906,356, filed on Feb. 27, 2018, which claims priority to and the benefit of U.S. Application 62/614,622, filed Jan. 8, 2018, the disclosures of which are incorporated herein by reference in their entirety.

### BACKGROUND OF THE INVENTION

The present invention relates to a wrench device for firmly gripping an object such as a container or jar. The invention further relates to a method of using such device for opening the lid of a container or jar.

Numerous devices have been devised for gripping an object such as a container or jar to facilitate opening a lid. The U.S. patent publication No. 2013/0298508, for example, discloses a “strap wrench” that can be applied to either a jar or a jar lid to firmly hold and to apply a torque to open the lid. In one embodiment two strap wrenches are used to allow a user to firmly hold the jar with one hand while applying torque to open the lid with the other.

Other devices for opening the lid of a jar may be found in the following patent references:

CN107176570 for “Bottle Cap Unscrewing Device”;

US20060112792 for “Strap Wrench”;

U.S. Pat. No. 6,425,305 for “Jar Holder”; and

U.S. Pat. No. 5,704,258 for “Bottle Opening Device”.

As evidenced by all of these references, so-called “strap wrench” has been frequently used to hold a container or jar to aid the user in opening the lid. This device was originally designed to grip an industrial object, such as a water pipe or an oil filter, with a relatively wide strap in order to hold or turn the pipe or filter while avoiding scarring, as would occur from the use of a toothed pipe wrench. The wrench's strap is in contact with nearly the entire circumference of the round object, and thus can apply the torsional force received from the handle which serves as a lever and that, depending on its length, multiplies the mechanical advantage.

Strap wrenches are commercially available wherever tools are sold. One such wrench, made by Flui-Pro Products, is the “Heavy-Duty Rubber Strap Wrench with Locking Non-Slip Grip.” This strap wrench has a plastic handle and a strap of sufficient length to surround a six-inch pipe or filter. While both economic and sturdy, this wrench requires some dexterity and manipulation to use because the strap must first be passed around the object to be gripped and then held tightly against the handle by a ratcheting mechanism. To undo the strap the ratcheting mechanism must first be released.

When opening the screw-cap lid of a container, torque must be applied in opposite directions to the lid, on one hand, and to the container on the other. Especially in the case of vacuum-packed food containers, the torque required is significant and, in particular for children and people of advanced age, the lid may be difficult to open.

The aforementioned patent publication No. 2013/0298508 proposes to solve this problem by using a strap wrench attached to the lid (FIG. 3), or by using two strap wrenches: one attached to the lid and another to the jar (FIG. 4 of the publication). In the former case, the jar is held in one hand while the wrench is turned with the other. In the latter case, one wrench is held stationary with one hand while the other wrench is turned by the other, free hand. Neither one of these proposed maneuvers is entirely satisfactory and convenient.

### SUMMARY OF THE INVENTION

A principal object of the present invention, therefore, is to provide an improved wrench device for firmly gripping an object, such as a container or jar, which is effective and robust, yet extremely convenient to use.

Another, ancillary object of the present invention is to provide a method of using the improved wrench device to unscrew the lid of a container or jar.

These objects, as well as further objects which will become apparent from the discussion that follows, are achieved by providing a strap wrench device of the type described above that includes:

(a) an elongate, flexible member having a first end and a second end; and
(b) an elongate handle having a proximal end, a distal end, a face side and a back side. The handle is configured to be conveniently held in a user's right hand with its proximal end extending toward the object to be gripped. The proximal end of the handle has a means on its right side (when held by a user with its face side up) for attaching the first end of the flexible member. It also has an opening adjacent the handle's left side through which the flexible member can pass.

The flexible member extends through the opening in the handle, thereby forming a loop that can surround and grip the object. The member then extends further along the left side of the handle toward the handle's distal end.

In accordance with the invention, the handle includes a rounded protrusion at its proximal end, adjacent to the opening and on a side of the opening that is opposite to the flexible member attachment means, for pressing the flexible member against the gripped object when the device is in use.

This protrusion serves as a means for “locking” the flexible member, and preventing slippage of the loop, with respect to the object when the handle is rotated clockwise.

The flexible member is preferably a substantially flat strap, because such would provide a maximum contact area with the object to be gripped. In this case, the opening in the handle is preferably a slit which accommodates the strap with minimum clearance so as to guide and hold the strap in position adjacent the object.

Preferably also, the flexible member has a rubber surface on the side thereof in contact with the object so as to prevent slippage.

In a preferred embodiment of the invention, the rounded protrusion is formed by an elongate hump that extends across the width of the handle, from its face side to its back side. This configuration distributes the force applied to the strap across the width of the strap.

Advantageously, the handle of the wrench device is made of a hard plastic, and the rounded protrusion is made of a different material than the handle, such as metal or rubber, and attached to the plastic handle either during or after the handle is cast in a mold. In this way, the protrusion can be configured to best serve its purpose as an abutment that maintains the strap in position even when a substantial torque force is applied to the wrench during use.

According to another preferred embodiment, the wrench device further comprises a guide member affixed to the handle that extends outward therefrom on the left side thereof, for guiding and retaining the flexible member in close proximity to the handle. The guide member is preferably made of a bent metal rod that is embedded at one end in the plastic material of the handle.

Another aspect of the present invention concerns a method for opening a lid of a container, using the wrench device described above. It is assumed that the lid is substantially round and is screwed on tightly, as is often the case with jars of food. The container may be, but is not necessarily, cylindrical in shape. It may be oval shaped, for instance, or even square.

The present method, which advantageously requires only a single wrench device, comprises the following steps:

(a) Surrounding the container with the flexible member, forming a snug loop around the container;
(b) With the left hand, grasping the container lid tightly between the left thumb and the left forefinger; and
(c) Rotating the wrench device clockwise with the right hand, to rotate the container while firmly holding the lid stationary with the left hand.

In so doing, the rounded protrusion presses against the flexible member, firmly fixing it in position and preventing slippage of the loop with respect to the container while the wrench device is rotated.

For a full understanding of the present invention, reference should now be made to the following detailed description of the preferred embodiments of the invention as illustrated in the accompanying drawings.

### BRIEF DESCRIPTION OF THE DRAWINGS

FIG. 1 is a perspective view showing a preferred embodiment of the wrench device according to the invention.

FIG. 2 is a face side view of the wrench device of FIG. 1.

FIG. 3 is a perspective view of the wrench device of FIG. 1, showing a first step of the method for opening a jar in accordance with the present invention.

FIG. 3A is a perspective view of the wrench device of FIG. 1, showing a second step of the method for opening a jar.

FIG. 4 is a perspective view showing a third step of the method for opening a jar.

FIG. 5 is a perspective view showing a fourth step of the method for opening a jar.

FIG. 6 is a perspective view showing a final step of the method for opening a jar.

### DETAILED DESCRIPTION OF THE PREFERRED EMBODIMENTS

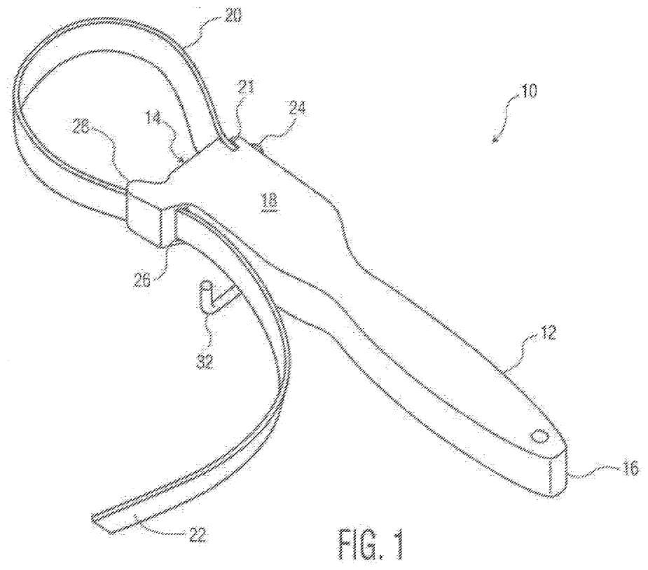

The preferred embodiment of the present invention will now be described with reference to FIGS. 1-6 of the drawings. Identical elements in the various figures are identified with the same reference numerals.

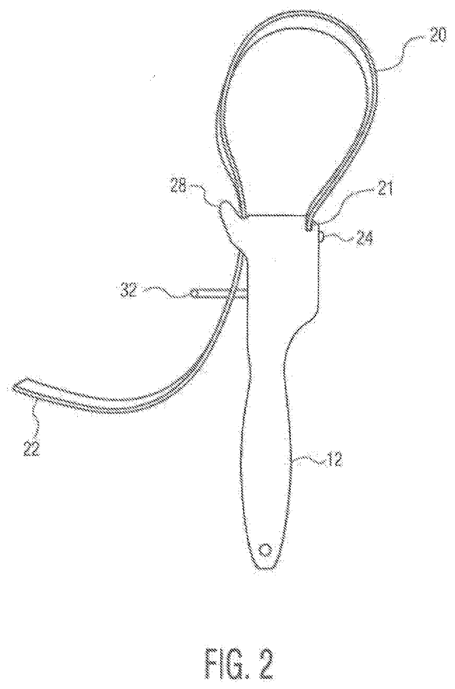

The wrench device according to the invention is shown generally in FIG. 1. A plan view of the device is shown in FIG. 2.

Referring to FIGS. 1 and 2, the wrench device 10 is shown comprising an elongate handle 12 having a “proximal end” 14, a distal end 16, and a face side 18. The handle is configured to be conveniently held in a user's right hand with its proximal end extending toward an object to be gripped.

The device also includes a flexible member 20 (in this case a strap) having a first end 21 and a second end 22. The proximal end of the handle has a means 24 on its right side (as viewed when the device is held by a user with its the face side 18 upward) for attaching the first end of the flexible member. This means may be a rivet (as shown), an eyelet or any common device for “fixing” the first end of the member to the handle.

The flexible member 20 forms a loop and passes through an opening 26, preferably a narrow slit if the member is a flat strap, on the left side of the handle's proximal end. The member 20 then extends further along the left side of the handle toward the handle's distal end 16.

In accordance with the invention, the handle includes a rounded protrusion 28 at its proximal end 14, adjacent to the opening 26 and on the side of the opening that is opposite to the flexible member attachment means 24. This protrusion 28 presses the flexible member tightly against a gripped object when the device is in use, preventing slippage of the member with respect to the object when the handle is rotated clockwise.

The flexible member 20 is preferably a substantially flat strap, because such would provide a maximum contact area with the object to be gripped. In this case, the opening 26 in the handle 12 is preferably a slit which accommodates the strap with minimum clearance so as to guide and hold the strap in position adjacent the object.

Preferably also, the flexible member 20 has a rubber surface on its side that is in contact with the object, so as to maximize friction and minimize slippage.

In the preferred embodiment of the invention, the rounded protrusion 28 is formed by an elongate hump that extends across the width of the handle, from the face side to its back side. This configuration distributes the force applied to the strap across the width of the strap.

Preferably, the handle 12 of the wrench device 10 is made of a hard plastic. The rounded protrusion 28 can be formed integrally with the handle, as is shown in FIGS. 1 and 2. Alternatively, however, it can be made a separate element of a different material than the handle, such as metal or rubber. For example, the separate element can be in the form of a short round rod attached to the plastic handle 12 either during or after the handle is cast in a mold. In this way, the protrusion 28 can be configured to best serve its purpose as an abutment that maintains the strap in position even when a substantial torque force is applied to the wrench during use.

According to another preferred embodiment of the invention, the wrench device further comprises a guide member 32 affixed to the handle, that extends outward therefrom on its left side, for guiding and retaining the flexible member 20 in close proximity to the handle. The guide member 32 may be made of a bent metal rod, for example, that is embedded and thereby fixed at one end in the plastic handle.

Another aspect of the present invention concerns a method for opening a lid of a container using the wrench device described above. It is assumed that the lid is substantially round and is screwed on tightly, as is often the case with jars of food. The container may be, but is not necessarily, circular in cross-sectional shape. Instead it may be oval shaped, for instance, or even square.

The present method, which advantageously requires only a single wrench device, preferably comprises the following steps:

(a) with the flexible member of the wrench device as described above, forming a snug loop around the container;
(b) grasping the container lid tightly between a left thumb and a left forefinger of the left hand; and
(c) rotating the wrench device clockwise with the right hand, to rotate the container while firmly holding the lid stationary with the left hand.

In so doing, the rounded protrusion presses against the flexible member, firmly fixing it in position and preventing slippage of the flexible member loop with respect to the container as the wrench device is rotated.

The device may be easily removed from the container in an additional, final step by rotating the device counter-clockwise with respect to the container to loosen the flexible member and then slipping the device off the top or bottom of the container.

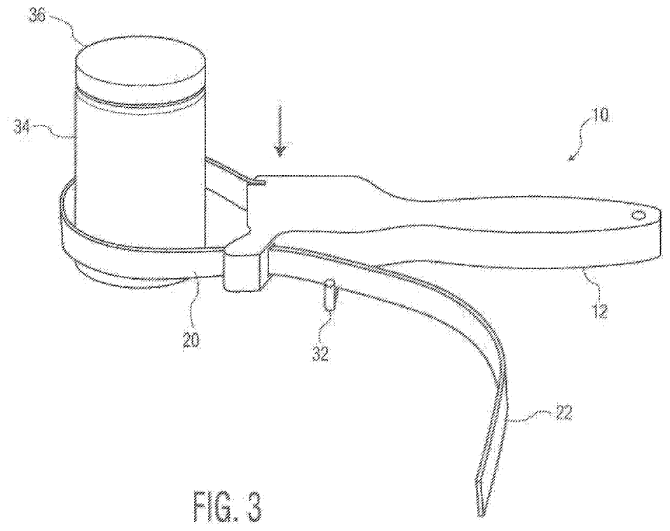

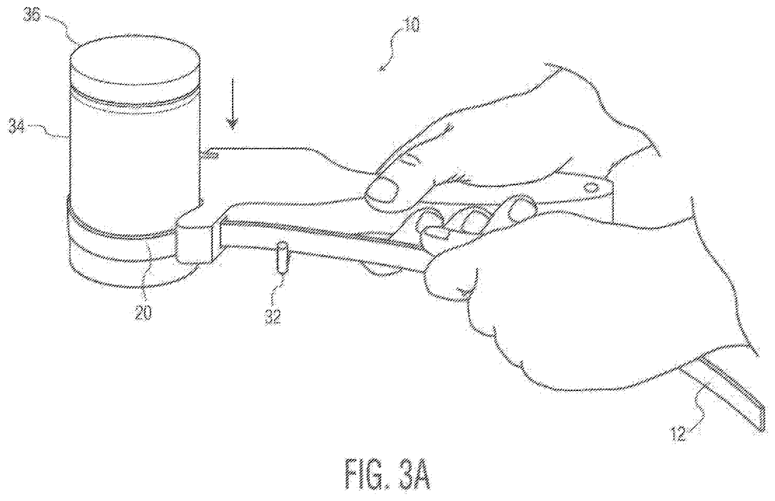

FIG. 3-6 illustrate this method. FIG. 3 illustrates the initial position of the wrench device 10 with respect to a jar 34 with a lid 36. The flexible member 20 is conveniently slipped around the jar 34. As shown in FIG. 3A, the flexible member is then pulled snug with the left hand while holding the wrench handle with the right hand.

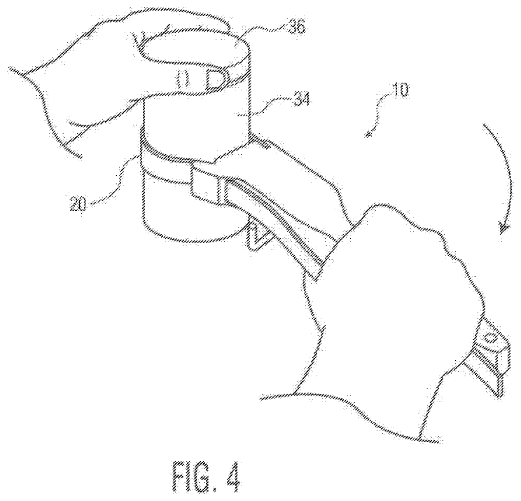

As shown in FIG. 4, the user grasps the wrench handle with his/her right hand and simply “anchors” the round lid or cap 36 with the left. Surprisingly, with this technique only a minimal “squeezing” effort is required to hold the lid stationary against the application of the opposing torsional force applied to the jar by the wrench. When the jar is turned clockwise by the wrench device, with the lid thus held steady, even the tightest lid can be loosened and unscrewed.

Thanks to the “jamming” of the cap or lid surface into the natural arc of the user's left hand, as compared to the “pulling-away” action if the user tries to rotate the cap counterclockwise with the right hand, the “squeezing” effort by the user to hold the lid tight against rotation with the jar is quite insubstantial and can be easily accomplished by anyone, from the very young to the very old.

The free end of the strap can be held tightly when the wrench device is in use by squeezing it firmly against the handle proper. Such a firm grip on the strap is not necessary, however, because it is pressed against the jar 34 by the round protrusion 28.

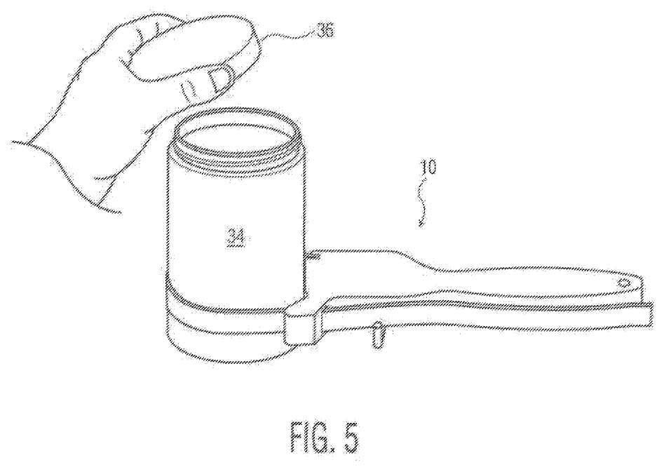

In FIG. 5 the wrench device is held with the right hand while the lid is removed with the left hand. The thumb and forefinger create a circular grip around the lid.

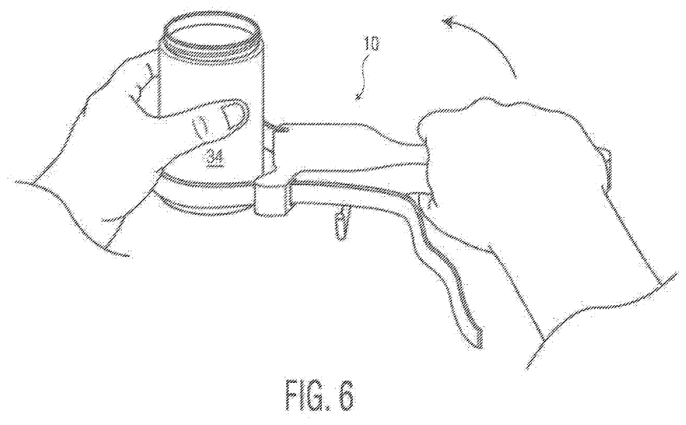

In FIG. 6 the lid has been removed, and the flexible member of the wrench device is loosened to enable removal. Once it is loosened, the wrench device can easily be slipped off of the jar.

There has thus been shown and described a strap wrench device, as well as a method for opening the lid of a container, both of which fulfill all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A wrench comprising:
a handle having a proximal end, a distal end and a grip portion extending longitudinally between the proximal end and the distal end, the proximal end having a first edge, a surface extending transversely from the first edge to a second edge opposite the first edge, a protrusion protruding from the surface immediately at the second edge, and an aperture formed at the second first edge between the protrusion and the surface; and
a strap having a first end and a second end, the second end being fixedly attached to the proximal end of the handle at the first edge, wherein the first end of the strap is able to pass through the aperture, and wherein a portion of the strap and the surface of the proximal end are structured to form a loop that surrounds and holds an object therein such that the surface and the portion of the strap forming the loop make direct contact with at least a portion of the object.

2. The wrench of claim 1, wherein when the strap is passed through the aperture, a second portion of the strap is disposed within the aperture immediately adjacent to the protrusion and between the protrusion and the first edge of the proximal portion.

3. The wrench of claim 1, wherein the proximal end of the handle has a fixing component at the first edge, and the second end of the strap is fixedly attached to the fixing component.

4. The wrench of claim 1, wherein the surface of the proximal end of the handle is flat.

5. The wrench of claim 1, wherein the protrusion is structured to be pressed against an external surface of the portion of the strap forming the loop such that the protrusion locks the portion of the strap forming the loop and the portion of the object in direct contact with the loop in one position during use of the wrench.

6. The wrench of claim 1, wherein the protrusion extends radially outwardly and longitudinally away from the distal end.

7. The wrench of claim 1, wherein the grip portion extends longitudinally from the first edge and the second edge of the proximal end and converges at the distal end of the handle.

8. The wrench of claim 7, wherein the aperture is a conduit for the strap to proceed therethrough, the conduit running straight from the second edge of the proximal end of the handle and an upper portion of the grip extending from the second edge.

9. The wrench of claim 1, wherein the protrusion is an attachment to the second edge of the proximal end of the handle.

10. A method for wrenching an object using a wrench, comprising:
providing a wrench comprising:
a handle having a proximal end, a distal end and a grip portion extending longitudinally between the proximal end and the distal end, the proximal end having a first edge, a surface extending transversely from the first edge to a second edge opposite the first edge, a protrusion protruding from the surface immediately at the second edge, and an aperture formed at the second first edge between the protrusion and the surface; and
a strap having a first end and a second end, the second end being fixedly attached to the proximal end of the handle at the first edge, wherein the first end of the strap is able to pass through the aperture, and wherein a portion of the strap and the surface of the proximal end are structured to form a loop that surrounds and holds an object therein such that the surface and the portion of the strap forming the loop make direct contact with at least a portion of the object;
forming a tight loop around the object with the portion of the strap and the flat surface of the proximal end of the handle;
rotating the wrench such that another portion of the object not in direct contact with the loop becomes loose from the portion of the object in direct contact with the loop; and
separating the another portion of the object not in direct contact with the loop from the portion of the object in direct contact with the loop.
